(19) United States
(12) Patent Application Publication
(10) Pub. No.: US 2021/0248600 A1
(43) Pub. Date: Aug. 12, 2021

(54) SYSTEM AND METHOD TO SECURE PAYMENT TRANSACTIONS

(71) Applicant: Mastercard International Incorporated, Purchase, NY (US)

(72) Inventors: Chandan Garg, Gurgaon (IN); Jaipal Singh Kumawat, Sikar (IN); Gurpreet Atwal, Chesterfield, MO (US)

(73) Assignee: Mastercard International Incorporated, Purchase, NY (US)

(21) Appl. No.: 16/784,586

(22) Filed: Feb. 7, 2020

(51) Int. Cl. G06Q 20/38; G06F 21/46

(52) U.S. Cl. CPC G06Q 20/385; G06F 21/46; G06Q 20/3829

(57) ABSTRACT

The disclosure includes systems and methods for authenticating a user with a one-time password having a one-time password offset parameter. The system receives a transaction authorization request message that includes a payment card identifier. A database is searched using the payment card identifier. The system retrieves contact details for a cardholder from the database. The system generates a one-time password and transmits the generated one-time password to the cardholder using the contact details. The system also receives a calculated one-time password response from the cardholder. The system retrieves a rule for producing the calculated one-time password response and a one-time password offset parameter from the database. A test one-time password is produced from the one-time password offset parameter based on the retrieved rule. The calculated one-time password response is compared to the test one-time password, and the calculated one-time password response value is authenticated based on a match.

### FIELD OF THE DISCLOSURE

The present disclosure relates to systems and methods for processing one-time passwords and in particular to enabling a cardholder to predefine an offset function to be applied to a one-time password.

### BACKGROUND OF THE DISCLOSURE

One-time passwords (OTPs) are often used in the verification of payment transactions. In the transaction authorization process, an OTP is sent as a text message, an email message, or other type of electronic communication to a cardholder's mobile telephone number or his or her email address. In order to verify that the transaction originated with the cardholder, the customer is prompted to enter the OTP at the time of checkout. Thus the use of OTPs can prevent or reduce fraudulent use of stolen payment cards by requiring an additional level of security. However, if a fraudster is able to intercept the transmission of the OTP, then the fraudster may still be able to perform fraudulent transactions using the cardholder's payment card.

### SUMMARY OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a system for authenticating a user with a one-time password is provided. The one-time password is associated with an offset parameter. The system includes a database and a processor. The database includes cardholder information for a cardholder. The cardholder information includes a payment card identifier, contact details for the cardholder, the one-time password offset parameter, and a rule for producing a calculated one-time password response value using the one-time password offset parameter. The processor is programmed to receive a transaction authorization request message. The transaction authorization request message includes the payment card identifier. The processor is programmed to search the database using the payment card identifier and retrieve the contact details for the cardholder based on the payment card identifier. Furthermore, the processor is programmed to generate a one-time password and transmit the generated one-time password to the cardholder using the contact details for the cardholder. The processor is programmed to receive the calculated one-time password response value from the cardholder and to retrieve, from the database, the rule for producing the calculated one-time password response value and the one-time password offset parameter. The processor is also programmed to produce a test one-time password from the one-time password offset parameter and the generated one-time password based on the retrieved rule. Moreover, the processor is programmed to compare the calculated one-time password response value to the test one-time password, and to authenticate the calculated one-time password response value based on the calculated one-time password response value matching the test one-time password.

In another aspect, a method for authenticating a user with a one-time password having a one-time password offset parameter is provided. The method includes receiving a transaction authorization request message. The transaction authorization request message includes the payment card identifier. The method also includes searching a database using the payment card identifier and retrieving, from the database, contact details for the cardholder based on the payment card identifier. The method includes generating a one-time password and transmitting the generated one-time password to the cardholder using the contact details for the cardholder. Furthermore, the method includes receiving a calculated one-time password response value from the cardholder. In addition, the method includes retrieving, from the database, a rule for producing the calculated one-time password response value and a one-time password offset parameter and producing a test one-time password from the one-time password offset parameter and the generated one-time password based on the retrieved rule. The method further includes comparing the calculated one-time password response value to the test one-time password and authenticating the calculated one-time password response value based on the calculated one-time password response value matching the test one-time password.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram illustrating an example multi-party payment card network system, in accordance with one embodiment of the present disclosure;

FIG. 2 is a block diagram of a transaction card account system, such as the network system shown in FIG. 1, showing data flow among the parties of the system;

FIG. 3 is an example configuration of a user system operated by a user, such as a cardholder shown in FIG. 1;

FIG. 4 is an example configuration of a server system, such as the interchange network shown in FIG. 1;

FIG. 5 is a block diagram of the one-time password service system shown in FIG. 1, illustrating the functional modules of the system, in accordance with one embodiment of the present disclosure;

FIG. 6 is a flowchart illustrating an exemplary computer-implemented method for defining an offset parameter component for processing a one-time password, in accordance with one embodiment of the present disclosure; and

FIG. 7 is a flowchart illustrating an exemplary computer-implemented method for processing a one-time password having a user-selected offset, in accordance with one embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

As used herein, the terms “transaction card,” “financial transaction card,” and “payment card” may include any suitable transaction card, such as a credit card, a debit card, a charge card, a membership card, a promotional card, an identification card, a prepaid card, a gift card, and/or any other device that may hold payment account information, such as a mobile phone, smart phone, personal digital assistant (PDA), key fobs, and/or computer. Each type of transaction card can be used as a method of payment for performing a transaction.

### Exemplary Payment Network Systems

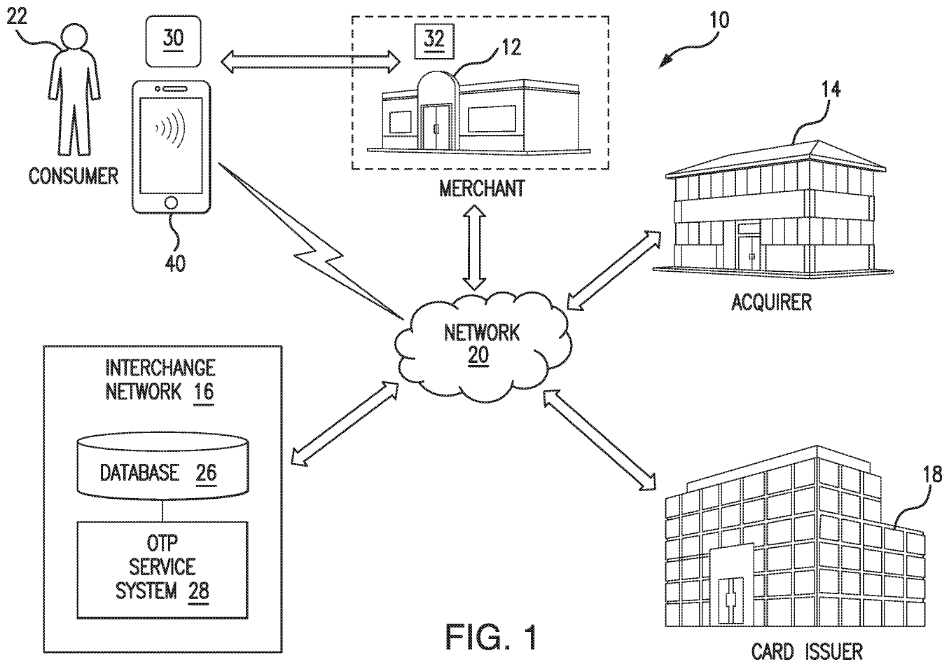

FIG. 1 is a block diagram illustrating an example multi-party payment card network system 10, in accordance with one embodiment of the present disclosure. The example payment card network system 10 generally includes merchants 12, acquirers 14, interchange networks 16, and card issuers 18, coupled in communication via a network 20. As used herein, the term “interchange network” includes an electronic network that exchanges data relating to the value of card sales and credits among the card issuers 18 and the acquirers 14.

The payment card network system 10 facilitates providing interchange network services offered by the interchange network 16. In addition, the payment card network system 10 enables payment card transactions in which the merchants 12, the acquirers 14, and/or the card issuers 18 do not need to have a one-to-one relationship. As an example, the payment card network system 10 may be utilized by the merchants 12 as part of a process of initiating a pre-authorization request for performing a transaction (as described herein). Although parts of the payment card network system 10 are presented in one arrangement, other embodiments may include the same or different parts arranged otherwise, depending, for example, on pre-authorization processes for purchase transactions, communication between computing devices, etc.

The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, the issuers 18, and/or a consumer or cardholder 22 (also referred to herein as a “user”). Additionally, the network 20 may include more than one type of network, such as a private payment transaction network provided by the interchange network 16 to the acquirers 14 and/or the card issuers 18, and separately, the public Internet, which may facilitate communication between the merchants 12, the interchange network 16, the acquirers 14, and/or the cardholders 22.

Embodiments described herein relate to a payment card system, such as a credit card payment system using the Mastercard® interchange network. (Mastercard is a registered trademark of Mastercard International Incorporated.) The Mastercard interchange network is a set of proprietary communications standards promulgated by Mastercard for the exchange of financial transaction data and the settlement of funds between financial institutions that are members of Mastercard. As used herein, financial transaction data includes a unique account number associated with an account holder using a payment card issued by a card issuer, purchase data representing a purchase made by the consumer, including a type of merchant, amount of purchase, date of purchase, and other data, which may be transmitted between any parties of the multi-party payment card network system 10.

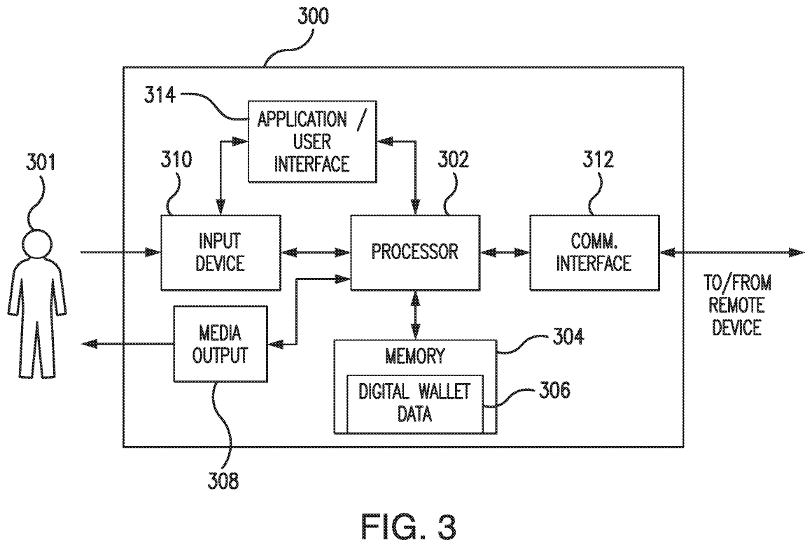

In a typical payment card system, a financial institution called the “issuer” issues a payment card 30, such as a debit card or credit card, to the user or cardholder 22, who uses the payment card 30 to tender payment for a purchase from the merchant 12. The cardholder 22 may, in some instances, enter the payment card information into a digital wallet (shown in FIG. 3) on a cardholder mobile device 40, which can then be used to tender payment for a purchase from the merchant 12. The merchant 12 is typically associated with products, for example, and without limitation, goods and/or services, that are offered for sale and are sold to the cardholders 22. The merchant 12 includes, for example, a physical location and/or a virtual location. A physical location includes, for example, a brick-and-mortar store, etc., and a virtual location includes, for example, an Internet-based store-front.

To accept payment with the payment card 30, the merchant 12 must normally establish an account with a financial institution that is part of the payment card network system 10. This financial institution is usually called the “merchant bank,” the “acquiring bank,” or the acquirer 14.

When the cardholder 22 provides payment for a purchase with the payment card 30 or the cardholder mobile device 40, the merchant 12 requests authorization from the acquirer 14 for the purchase amount. The request may be performed over the telephone but is usually performed using a point-of-sale (POS) terminal, such as a POS terminal 32, that reads the consumer's account information from a magnetic stripe, a chip, or embossed characters on the payment card 30 and/or receives a payment token from the mobile device, and communicates electronically with the transaction processing computers of the acquirer 14. However, in some embodiments, the payment card transaction is a card-not-present (CNP) account-on-file transaction in which a payment card is not presented to the merchant 12 during a transaction. In such CNP transactions, for example, the merchant 12 may have stored the cardholder's payment card account information from a previous transaction or may have stored the information based on an agreement for initiating recurring transactions. This information is then communicated electronically with the transaction processing computers of the acquirer 14. In some embodiments, the acquirer 14 may authorize a third party (not shown) to perform transaction processing on its behalf. In this case, the POS terminal 32 will be configured to communicate with the third party. Such a third party is usually called a “merchant processor,” an “acquiring processor,” or a “third party processor.”

Using the interchange network 16, computers of the acquirer 14 or merchant processor will communicate with computers of the card issuer 18 to determine whether the cardholder's account is in good standing and whether the purchase is covered by the cardholder's available credit line. Upon submission of an authorization request to the card issuer 18 via the interchange network 16, the interchange network identifies the payment transaction authorization request as requiring one-time password (OTP) verification. An OTP service system 28 retrieves contact information for the cardholder 22 from a database 26. This retrieval process may involve using a payment card identifier (e.g., a primary account number (PAN)) to identify the cardholder's contact details, such as a mobile telephone number for the cardholder 22. The interchange network 16 sends an OTP request to the merchant 12, for example, via the POS terminal 32, requesting an OTP from the cardholder 22. In addition, the interchange network 16 sends an OTP message to the cardholder 22, via the cardholder mobile device 40.

In the exemplary embodiment, when the cardholder 22 opts-in or registers with the interchange network 16 to receive a one-time password (also referred to as a one-time use short code) before completing transactions, the cardholder determines an “offset” to be applied to the one-time password. For example, the cardholder 22 may choose a simple value to be added or subtracted from the one-time password or he or she may define a mathematical formula to be applied. After applying the “offset” to the received one-time password, the cardholder 22 provides a response to the OTP request. If the cardholder 22 provides a valid OTP response to the OTP request at the POS terminal 32, the authorization request message is transmitted to the card issuer 18. Based on a determination regarding the cardholder's account standing and funds availability, the request for authorization will be declined or accepted. If the request is accepted, an authorization code is issued to the merchant 12. If the OTP response is invalid, the authorization request may be automatically declined by the interchange network 16.

When a request for authorization is accepted, the available funds or a credit line of the cardholder's account is decreased. Normally, a charge for a payment card transaction is not posted immediately to the cardholder's account because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the cardholder 22 cancels a transaction before it is captured, a “void” is generated. If the cardholder 22 returns goods after the transaction has been captured, a “credit” is generated. In some instances, if the cardholder 22 did not authorize the transaction, such as a previously cancelled recurring payment or a card-not-present (CNP) account-on-file transaction, a “chargeback” is generated. The interchange network 16 and/or the card issuer 18 stores the transaction data, such as, and without limitation, the PAN and expiry date of the payment card 30, a type of merchant, a merchant identifier, a location where the transaction was performed, a dollar amount of the transaction, a merchant category code, a date and time of the transaction, products purchased and related descriptions or identifiers, etc., in a transaction database (not shown).

After the transaction has been authorized, a clearing process occurs to transfer additional transaction data related to the transaction among the parties to the transaction, such as the acquirer 14 and the card issuer 18. More specifically, during and/or after the clearing process, additional data, such as a time of purchase, a merchant name, a type of merchant, purchase information, consumer account information, a type of transaction, itinerary information, information regarding the purchased item and/or service, and/or other suitable information, is associated with the transaction and transmitted between parties to the transaction as transaction data, and may be stored by any of the parties to the transaction.

While only one merchant 12, acquirer 14, interchange network 16, and card issuer 18 are shown in FIG. 1 (for ease of reference), it should be appreciated that a variety of other embodiments may include multiple ones of these parties in various combinations.

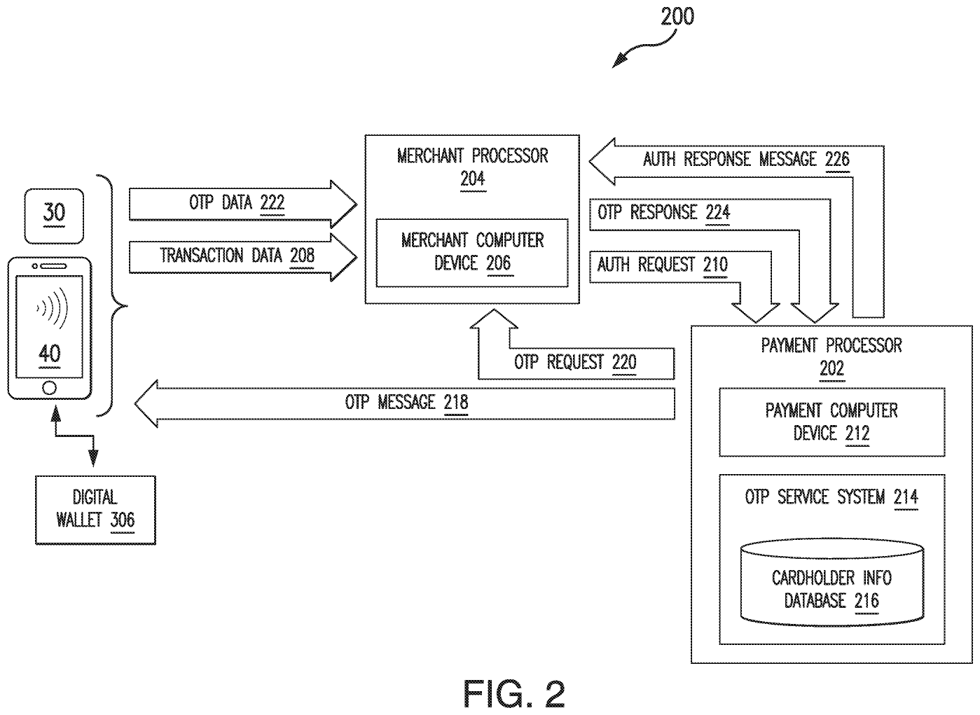

FIG. 2 is a block diagram of a transaction card account system 200 showing data flow among the payment card 30 and/or the cardholder's mobile device 40, a payment processor 202, and a merchant processor 204. In the example embodiment, the system 200 is a transaction card account system such as the payment card network system 10 (shown in FIG. 1). In some embodiments, the payment processor 202 is an interchange network, such as the interchange network 16 (shown in FIG. 1). The cardholder mobile device 40 is configured to allow the cardholder 22 (shown in FIG. 1) to access the payment processor 202 and the merchant processor 204, for example, via the POS terminal 32 (shown in FIG. 1), and electronically transact with the payment processor 202 and/or the merchant processor 204 to purchase goods or services associated with the merchant 12 (shown in FIG. 1). In the example embodiment, the cardholder mobile device 40 is coupled in communication with one or more of the POS terminal 32 and the payment processor 202.

In the example embodiment, the merchant processor 204 includes a merchant computer device 206. The merchant computer device 206 is a computer device such as the POS terminal 32. The merchant computer device 206 is a service-provided device that is coupled in communication with the merchant processor 204.

In the exemplary embodiment, the payment card 30 and/or the cardholder mobile device 40 transmit transaction data 208 to the merchant computer device 206 when making a purchase from the merchant 12. In one embodiment, the cardholder mobile device 40 is configured to transmit the transaction data 208 wirelessly via a transceiver 312 (shown in FIG. 3) to the merchant computer device 206 (i.e., the POS terminal 32). In certain embodiments, the payment card 30 is configured to transmit the transaction data 208 via a magnetic swipe, EMV chip, or wirelessly, via NFC-enabled circuitry. The transaction data 208 may include, for example, transaction information that indicates a purchased item identifier associated with the goods and/or services the cardholder 22 would like to purchase and a payment credential (e.g., digital wallet data 306 (shown in FIG. 3)).

The merchant processor 204 receives the transaction data 208 and generates a payment authorization request message 210. The payment authorization request message 210 is transmitted to the payment computer device 212 for processing and further transmission to an issuing bank for approval. In one embodiment, the payment computer device 212 includes an interchange computer associated with an interchange.

If the cardholder 22 has registered or is otherwise participating in the one-time password (OTP) service, an OTP service system 214 retrieves cardholder information from a cardholder information database 216. The OTP service system 214 generates a one-time password and transmits the password to the cardholder mobile device 40 as an OTP message 218. In addition, the OTP service system 214 transmits an OTP request message 220 to the merchant computer device 206 to request entry of the one-time password.

In one embodiment, the cardholder mobile device 40 is configured to transmit OTP data 222 (e.g., the one-time password with an “offset”) to the POS terminal 32. In certain other embodiments, the cardholder mobile device 40 displays the OTP data 222 to the cardholder 22, who applies an “offset” value/calculation to the one-time password and transmits the OTP data 222 manually into the merchant computer device 206. The merchant computer device 206 is configured to transmit an OTP response message 224 to the OTP service system 214 via, for example, the payment computer device 212. The OTP response message includes, for example, the OTP data 222 received from the cardholder 22 and/or the cardholder mobile device 40. A payment authorization response message 226 is received from the issuing bank and transmitted to the merchant computer device 206 by the payment computer device 212.

### Exemplary Computer Systems

FIG. 3 is an example configuration of a user system 300 operated by a user 301, such as the cardholder 22 (shown in FIG. 1). In some embodiments, the user system 300 is the cardholder mobile device 40 and/or the merchant POS terminal 32. In the example embodiment, the user system 300 includes a processor 302 for executing instructions. In some embodiments, executable instructions are stored in a memory device 304. The processor 302 includes one or more processing units, for example, a multi-core configuration. The memory device 304 is any device allowing information such as the digital wallet data 306, executable instructions, and/or written works to be stored and retrieved. The memory device 304 includes one or more computer readable media.

The user system 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

The user system 300 includes an input device 310 for receiving input from the user 301. The input device 310 may include, for example, a touch sensitive panel, a touch pad, a touch screen, a stylus, a gyroscope, an accelerometer, a position detector, a keyboard, a pointing device, a mouse, or an audio input device. A single component, such as a touch screen, may function as both an output device of the media output component 308 and the input device 310. The user system 300 may also include a communication interface 312, which is communicatively connectable to a remote device such as the interchange network 16 and/or the POS terminal 32 (shown in FIG. 1). The communication interface 312 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

The user system 300 includes a software application/user interface 314, which may be embodied, controlled, and/or executed by the processor 302. The application/user interface 314 may be hosted by a cloud-based computing device (e.g., a web server or the like (not shown)) without departing from the spirit of the present disclosure, for instance where the application/user interface 314 is accessed remotely by the user system 300 that is external to an organization managing the application/user interface 314, such as the interchange network 16. In certain embodiments, access to the application/user interface 314 is granted via a common authentication framework, such as through known single sign-on (SSO) processes.

Stored in the memory device 304 are, for example, computer readable instructions for providing the user interface 314 to the user 301 via the media output component 308 and, optionally, receiving and processing input from the input device 310. A user interface may include, among other possibilities, a web browser and/or a client application. Web browsers enable users, such as the user 301, to display and interact with media and other information typically embedded on a web page or a website provided, for example, by a merchant 12, the interchange network 16, the card issuer 18, and the like, whereas a client application allows the user 301 to interact with a server application provided, for example, by a merchant 12, the interchange network 16, the card issuer 18, and the like.

In the example embodiment, the user system 300 is a cardholder mobile device from which the user 301 may engage with a digital wallet 306, an online merchant (e.g., the merchant 12 shown in FIG. 1), an interchange network (e.g., the interchange network 16 shown in FIG. 1), and an issuer of a payment card (e.g., the card issuer 18 shown in FIG. 1) to perform a payment transaction that undergoes a one-time password authentication process.

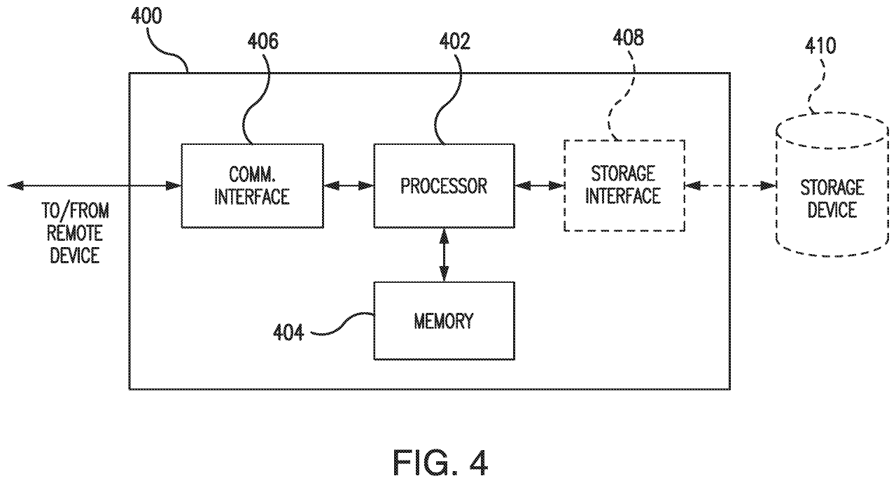

FIG. 4 is an example configuration of a server system 400, such as the interchange network 16 (shown in FIG. 1). The server system 400 includes and/or is coupled to, but is not limited to, the database 26 (shown in FIG. 1) and/or the cardholder information database 216 (shown in FIG. 2). In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as a user system 300 (shown in FIG. 3) or another server system. For example, the communication interface 406 may receive communications from a client system 32 via the Internet, as illustrated in FIG. 2.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the database 26 and/or the cardholder information database 216. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory device 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Exemplary One-Time Password Service System

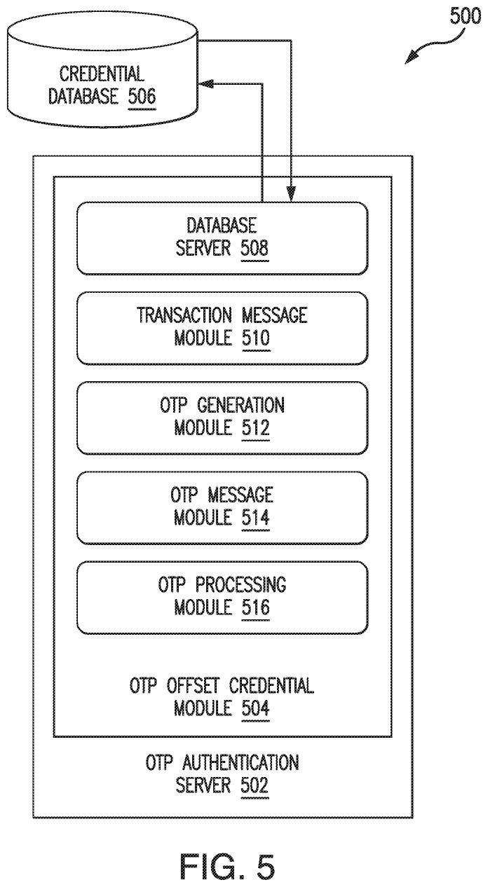

FIG. 5 is a block diagram of an example OTP service system 500, such as the OTP service system 28 (shown in FIG. 1), illustrating the functional modules of the system, in accordance with one embodiment of the present disclosure. In the exemplary embodiment, the OTP service system 500 is part of the interchange network 16 (shown in FIG. 1). However, it is noted that various operations or functions of the OTP service system 500 may be implemented on other parts of the system 10 (shown in FIG. 1). For example, and without limitation, in certain embodiments, the card issuer 18 may carry out OTP verification. Furthermore, various operations or functions of the OTP service system 500 may be implemented in other systems not shown, such as transaction systems configured for authorizing automated teller machine (ATM) transactions.

In the exemplary embodiment, the OTP service system 500 includes an OTP authentication server 502 having an OTP offset credential module 504, and a credential database 506, such as the cardholder information database 216 (shown in FIG. 2). The OTP authentication server 502 is a specially programmed computer system that enables the cardholder 22 (shown in FIG. 1) to implement user-selected offset value OTP login credentials to facilitate identifying and authenticating the cardholder 22, for example, when performing a payment transaction, for example, at a merchant 12 via a POS terminal 32.

The components illustrated in FIG. 5 are shown as functional components of the OTP service system 500. In some embodiments, the individual components may be a hardware component, a software component, or a combination of hardware and software components. Some of the components may include application level software, while other components may be execution environment level components. It is contemplated that two or more of the components may operate on a single hardware platform. Each embodiment described herein may use different combinations of hardware, software, and interconnections to achieve the methods and/or techniques described herein.

While the OTP service system 500 is shown in FIG. 1 as multiple components implemented on a standalone computing device, it is noted that the OTP service system 500 may be implemented on or distributed among a plurality of computing devices. The configuration of the OTP service system 500 is flexible and may be implemented in various different environments and configurations without compromising any major functionality. The systems and processes are not limited to the specific embodiments described herein. In addition, components of each system and each process can be practiced independent and separate from other components and processes described herein. Each component and process can also be used in combination with other assembly packages and processes.

In the exemplary embodiment, the OTP authentication server 502 is a server computing device, such as the server system 400 as described in FIG. 4. In alternative embodiments, the OTP authentication server 502 may include, without limitation, a conventional desktop computing device, a laptop computing device, a netbook computing device, a tablet or slate computing device, a wireless handset, a cellular telephone, a game console, or any other type of computing device that can store and/or execute the OTP offset credential module 504 thereon and communicate with, for example, the cardholder mobile device 40 and the POS terminal 32 (each shown in FIG. 1). In some embodiments, the OTP authentication server 502 may be implemented in a cloud computing environment. For example, and without limitation, the functionality of the OTP authentication server 502 disclosed herein may be provided by executing one or more applications, such as the OTP offset credential module 504, in a cloud computing environment. Cloud computing typically includes providing computing services via a network connection, such as the network 20 (shown in FIG. 1), using dynamically scalable computing resources. A cloud computing environment may be established by an enterprise and/or may be hired on an as-needed basis from a third-party provider.

The credential database 506 is a data store configured to store cardholder information for the cardholders 22. For example, and without limitation, the credential database 506 includes payment card identifiers (e.g., primary account numbers (PANs)), a cardholder's contact details (e.g., a mobile telephone number and/or email address for cardholders), and OTP offset parameters and/or rules. The credential database 506 may include a single database having separated sections or partitions or may include multiple databases, each being separate from each other. In one suitable embodiment, the credential database 506 is a relational database where the payment card identifiers, contact details, and OTP offset parameters and/or rules are stored in tables.

As described in FIG. 3, a user system 300 (e.g., the cardholder mobile device 40) includes an application/user interface 314 that a user, such as the cardholder 22, utilizes to register with the OTP service system 500 and/or input OTP offset parameters and/or rules. For example, and without limitation, the application/user interface 314 enables the cardholder 22 to input information to the cardholder mobile device 40 and the cardholder mobile device 40 to output information to the cardholder 22 (e.g., on a display of the user interface 314). As described herein, the application/user interface 314 includes, for example, a web browser that receives webpages from the OTP authentication server 502, such that the OTP authentication server 502 is accessible to the cardholder mobile device 40 via the network 20. In some embodiments, the application/user interface 314 may include a discrete software program that interfaces directly with the OTP authentication server 502.

As disclosed herein, the OTP authentication server 502 includes the OTP offset credential module 504. The OTP offset credential module 504 includes, for example, and without limitation, a database server 508, a transaction message module 510, an OTP generation module 512, an OTP message module 514, and an OTP processing module 516.

In the exemplary embodiment, the OTP offset credential module 504 receives OTP offset data corresponding to a user, such as the cardholder 22, from a cardholder mobile device 40 or another cardholder computing device. As described herein, the OTP offset data includes, for example, a payment card identifier, a cardholder's contact details, and OTP offset parameters and/or rules. The payment card identifier, contact details, and OTP offset parameters and/or rules are stored, for example, on the credential database 506 for later retrieval.

As is described herein, when a merchant submits a payment authorization request message, such as the payment authorization request message 210 (shown in FIG. 2), the OTP offset credential module 504 attempts to match the payment card identifier contained in the payment authorization request message to a payment card identifier stored on the credential database 506. When a match is identified, the OTP offset credential module 504 identifies the corresponding cardholder contact information, such as a mobile telephone number or email address, generates an OTP, and transmits the OTP to the cardholder mobile device 40 based on the contact information. In addition, the OTP offset credential module 504 transmits an OTP request message to the merchant 12. The OTP offset credential module 504 searches the credential database 506, e.g., an OTP offset parameters table, for any OTP offset parameters and/or rules, and based on the defined parameters and/or rules found therein, generates a test OTP.

The cardholder 22 submits OTP data to the merchant POS terminal 32 in response to an OTP request presented to the cardholder 22 by the POS terminal. In particular, the cardholder 22 receives the OTP from the OTP offset credential module 504, applies his or her selected offset value based on the previously defined offset parameters and/or rules, and enters his or her response (e.g., the OTP data 222 (shown in FIG. 2)) into the POS terminal 32. The merchant transmits an OTP response message back to the OTP offset credential module 504 containing the cardholder's OTP data.

If the test OTP and the OTP data submitted by the cardholder 22 match, the OTP offset credential module 504 passes a payment authorization response message 226 to the merchant, thereby enabling the transaction to be completed. If the test OTP and the OTP data submitted by the cardholder 22 do not match, the OTP offset credential module 504 declines the transaction.

In the exemplary embodiment, the database server 508 is coupled in communication to the credential database 506, which is configured to store information on a variety of matters, including the payment card identifier, the cardholder's contact details, and the OTP offset parameters and/or rules, as described above. In one embodiment, the credential database 506 is a centralized database stored on the OTP authentication server 502. In an alternative embodiment, the credential database 506 is stored remotely from the OTP authentication server 502 and may be a distributed or non-centralized database, as described herein.

The database server 508 operates, in part, to receive input data from a cardholder, such as the cardholder 22, during a registration process. The database server 508 receives the cardholder's payment card identifier, contact details, and OTP offset parameters and/or rules from the cardholder 22, for example, via the cardholder mobile device 40, and stores this information in the credential database 506.

The transaction message module 510 is coupled to a payment network (such as the interchange network 16) or other network which allows the OTP service system 28 to send and receive transaction related messages to and from other computing devices involved in a payment transaction authorization process. In addition, the transaction message module 510 parses the incoming payment authorization request messages to identify the associated PANs and passes this information to the database server 508 to perform one or more lookup operations.

The OTP generation module 512 is configured to generate an OTP, for example, as a random sequence of characters. Typically, the OTP has a fixed number of elements as defined by a system administrator, where the elements generally include ASCII characters. Alternatively, the OTP can have a variable number of elements, usually with a minimum number of elements, as defined by a system administrator. The OTP generation module 512 may include, for example, a random number generator (RNG) for determining the elements of the OTP.

The OTP message module 514 is a communication module that is configured to transmit the OTP generated by the OTP generation module 512 to the cardholder 22. For example, the OTP message module 514 is connected to the network 20 and transmits the OTP to the cardholder mobile device 40 via, for example, an SMS message and/or an email message (based on the cardholder's contact information). In addition, the OTP message module 514 is in communication with the merchant POS terminal 32 for transmitting the OTP request message 220 to and receiving the OTP response message 224 therefrom.

The OTP processing module 516 generates a rule to be stored and associated with the cardholder information in the credential database 506. Using the application/user interface 314 (shown in FIG. 3) of the cardholder mobile device 40 or other computing device, the cardholder 22 enters an offset value or calculation to be applied to the generated OTP when performing a transaction. The rule is defined by one or more user selected parameter components during the registration process. As described herein, the rule is stored in the credential database 506.

In addition, the OTP processing module 516 receives from the merchant 12, via the POS terminal 32, an OTP response message that contains the cardholder's OTP data. The OTP processing module 516 searches the credential database 506 for a matching payment card identifier based on the payment authorization request message. After identifying an entry matching the payment card identifier, the OTP processing module 516 retrieves the one or more parameters and/or rules associated with the entry. Based on parameters and/or rules retrieved from the credential database 506, the OTP processing module 516 generates a test OTP, compares the test OTP to the received OTP data, and authenticates the cardholder 22 if the comparison operation indicates a match.

### Exemplary Computer-Implemented Methods

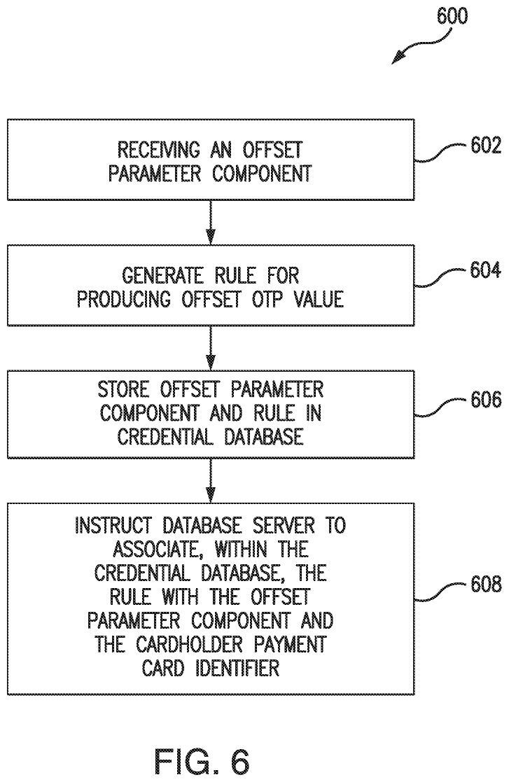

FIG. 6 is a flowchart illustrating an exemplary computer-implemented method 600 for defining an offset parameter component for processing a one-time password (OTP), in accordance with one embodiment of the present disclosure. The operations described herein may be performed in the order shown in FIG. 6 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 600 is described below, for ease of reference, as being executed by exemplary devices and components introduced with the embodiments illustrated in FIGS. 1-5. In one embodiment, the computer-implemented method 600 is implemented by the OTP service system 28 (shown in FIG. 1). In the exemplary embodiment, the computer-implemented method 600 relates to an OTP having a user-selected offset. While operations within the computer-implemented method 600 are described below regarding the OTP service system 28, according to some aspects of the present invention, the computer-implemented method 600 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

The method 600 includes, in operation 602, receiving an offset parameter component for applying to an OTP. For example, and without limitation, the cardholder 22 enters or selects, for example, via the application/user interface 314, an offset parameter component to be applied to an OTP when processing a payment transaction. In particular, the application/user interface 314 presents an option to the cardholder 22 for configuring an offset parameter component to be applied to an OTP that will be transmitted to the cardholder during a payment transaction. The application/user interface 314 may present a list of user-selectable mathematical operations along with user-selectable offset parameter components. It is noted that the user-selectable offset parameter components may include any numerical variable that is determinable at a specific time by both the cardholder 22 and the OTP authentication server 502, such that an OTP response value is determinable.

For example, the cardholder 22 may select to perform a mathematical operation, such as addition, subtraction, multiplication, or division, to combine the offset parameter component and the generated OTP. In another embodiment, the cardholder 22 may select to combine the generated OTP and the offset parameter component by prepending or appending the offset parameter component to the generated OTP.

The offset parameter component may include stock values, market index values, exchange rates, temperatures, locations, and the like. Furthermore, and without limitation, the offset parameter components may include a DATE association (e.g., day of the month, year, etc.), a TIME (e.g., a time of the transaction attempt, etc.), or any other dynamic offset parameter component that enables the subsequent determination of the OTP response value. As such, the offset parameter component may be a discrete determinable parameter, such as a number, DAY, TIME, etc., or may be a class of determinable parameters, such as stock values, that include a plurality of subcomponents that are discrete determinable parameters. The list of acceptable offset parameter components is predetermined by the administrator of the OTP authentication server 502.

At operation 604, the OTP authentication server 502, and more particularly, the OTP processing module 516, generates a rule for producing the offset OTP value (also referred to herein as the test OTP value). For example, and without limitation, the OTP processing module 516 generates a rule for storing in the credential database 506 (shown in FIG. 5). The rule serves to instruct the OTP authentication server 502 to perform the predetermined operation on the generated OTP using the offset parameter component, as defined by the cardholder 22.

At operation 606, the database server 508 stores the offset parameter component and the generated rule in the credential database 506. In particular, in the exemplary embodiment, the OTP processing module 516 passes the generated rule to the database server 508 for storage. As described above, the offset parameter component is determined by the cardholder 22 and input to the database server 508 using, for example, the application/user interface 314. The database server 508 communicates with the credential database 56 and stores the offset parameter component and the rule as retrievable data for subsequent use by the OTP authentication server 502. Furthermore, at operation 608, the OTP processing module 516 instructs the database server 508 to associate, within the credential database 506, the rule with the offset parameter component and the cardholder payment card identifier.

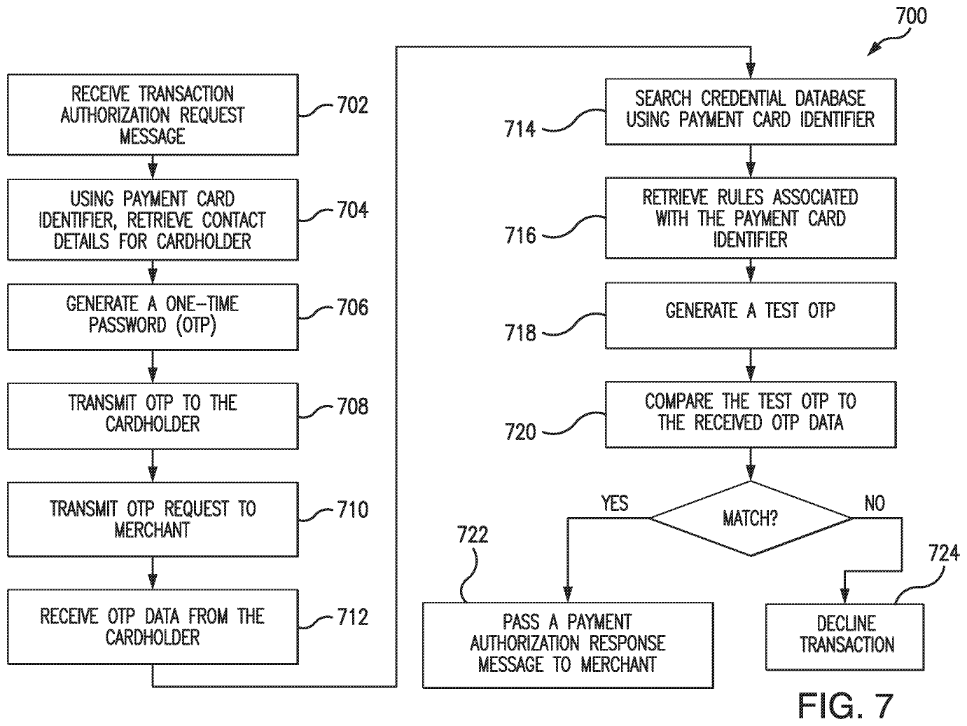

FIG. 7 is a flowchart illustrating an exemplary computer-implemented method 700 for processing a one-time password (OTP) having a user-selected offset, in accordance with one embodiment of the present disclosure. The operations described herein may be performed in the order shown in FIG. 7 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 700 is described below, for ease of reference, as being executed by exemplary devices and components introduced with the embodiments illustrated in FIGS. 1-5. In one embodiment, the computer-implemented method 700 is implemented by the OTP service system 28 (shown in FIG. 1). While operations within the computer-implemented method 700 are described below regarding the OTP service system 28, according to some aspects of the present invention, the computer-implemented method 700 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In operation step 702, the transaction message module 510 of the OTP service system 28 receives a transaction authorization request message, such as the transaction authorization request message 2210 (shown in FIG. 2). The transaction authorization request message may be received from a merchant, such as the merchant 12, or an acquirer, such as the acquirer 14 (each shown in FIG. 1). The transaction authorization request message includes, for example, and without limitation, a payment card identifier, a transaction amount, a merchant name, a merchant identifier, a merchant category code (MCC), a merchant location, and the like.

In operation 704, the database server 508 of the OTP service system 28 parses the transaction authorization request message and uses the payment card identifier to retrieve (e.g., look up) contact details for the cardholder, such as the cardholder 22 (shown in FIG. 1). The contact details include, for example, a mobile telephone number, email address, or other messaging information for contacting the cardholder. It is noted that the contact details may include more than one messaging system for contacting the cardholder and may include a preferred method of contact.

In operation 706, the OTP generation module 512 of the OTP service system 28 generates an OTP to be transmitted to the cardholder. As described herein, the OTP is a random sequence of characters, typically of a defined length. In a preferred embodiment, the OTP includes six (6) characters, forming a random 6-digit number. In operation 708, the OTP is transmitted to the cardholder by the OTP message module 514 of the OTP service system 28. In particular, the OTP is transmitted to the cardholder using the cardholder's preferred method of contact. It should be noted, that in some embodiments, the cardholder may not select a preferred method of contact. In such instances, the OTP may be transmitted using each of the cardholder's stored methods of contact, or a system administrator of the OTP service system 28 may designate a particular form of contact as a default preferred method.

In operation 710, an OTP request message is transmitted to the merchant associated with the transaction authorization request message by the OTP message module 514. In particular, the OTP request message is transmitted to the merchant's POS terminal, such as the POS terminal 32, requesting the cardholder to enter his or her OTP data before further processing of the transaction is performed. In the exemplary embodiment, the OTP service system 28 delays further processing for a predetermined period after transmitting the OTP to the cardholder and the OTP request message to the merchant. This provides the cardholder with a period in which to respond to the OTP request message. For example, and without limitation, in one suitable embodiment, the OTP service system 28 may delay further processing for a period of sixty (60) seconds.

In operation 712, the OTP message module 514 receives OTP data from the cardholder, for example, via the merchant. The OTP data includes a calculated OTP response value that was entered into the merchant POS by the cardholder 22. As described herein, the cardholder determines an appropriate OTP response value based on the generated OTP and his or her predetermined offset. After determining the appropriate response values, the cardholder submits the value to the POS terminal in response to the OTP request.

In operation 714, the OTP processing module 516 searches a credential database, such as the credential database 506 (shown in FIG. 5), using the payment card identifier. In the exemplary embodiment, the credential database 506 includes a rules table including one or more rules table records. Each rules table record includes a primary key and a rule entry of a rule for producing an offset OTP value. In addition, the credential database 506 includes a cardholder information table including one or more cardholder table records. Each cardholder table record includes a foreign key and a payment card identifier entry. The foreign key references a primary key of the rules table, which is associated with a specific rule for generating an offset OTP associated with the respective payment card identifier.

In one embodiment, the search operation 714 includes searching the cardholder information table and identifying a cardholder table record having a payment card identifier entry that matches the payment card identifier extracted from the transaction authorization request message. The foreign key of the identified cardholder table record is retrieved, and the referenced rule is identified in the rule table based on a matching primary key.

At operation 716, the OTP processing module 516 retrieves one or more rules associated with the entry payment card identifier. The rule(s) identifies an offset parameter component and an instruction for applying the offset parameter component to the generated OTP (e.g., appending, prepending, or applying a mathematical function) to generate a test OTP. Based on one or more rules retrieved from the credential database 506, at operation 718, the OTP processing module 516 generates the test OTP. More specifically, the OTP processing module 516 retrieves a value for the offset parameter component identified by the rule. The generated OTP and the value for the offset parameter component are combined as specified by the rule. The result is the test OTP.

At operation 720, the OTP processing module 516 compares the test OTP to the received OTP data (e.g., the calculated OTP response value), and if the comparison operation indicates a match, the OTP processing module 516 authenticates the cardholder. At operation 722, the transaction message module 510 passes a payment authorization response message, such as the payment authorization response message 226 (shown in FIG. 2), to the merchant, thereby enabling the transaction to be completed. If the test OTP and the OTP data submitted by the cardholder 22 do not match, at operation 724, the OTP offset credential module 504 declines the transaction.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A system for authenticating a user with a one-time password having a one-time password offset parameter, said system comprising:
a database comprising cardholder information for a cardholder, the cardholder information including one or more of the following: a payment card identifier, contact details for the cardholder, the one-time password offset parameter, and a rule for producing a calculated one-time password response value using the one-time password offset parameter; and
a processor coupled to said database, said processor programmed to:
receive a transaction authorization request message, the transaction authorization request message including the payment card identifier;
search said database using the payment card identifier;
retrieve the contact details for the cardholder based on the payment card identifier;
generate a one-time password;
transmit the generated one-time password to the cardholder using the contact details for the cardholder;
receive the calculated one-time password response value from the cardholder;
retrieve, from said database, the rule for producing the calculated one-time password response value and the one-time password offset parameter;
produce a test one-time password from the one-time password offset parameter and the generated one-time password based on the retrieved rule;
compare the calculated one-time password response value to the test one-time password; and
authenticate the calculated one-time password response value based on the calculated one-time password response value matching the test one-time password.

2. The system in accordance with claim 1,
the contact details for the cardholder including a preferred method of contact,
said processor being further programmed, as part of the operation of transmitting the generated one-time password to the cardholder, to transmit the generated one-time password using the preferred method of contact of the cardholder.

3. The system in accordance with claim 2,
said processor further programmed to delay further processing for a predetermined period after transmitting the generated one-time password to the cardholder.

4. The system in accordance with claim 1,
the transaction authorization request message including information identifying a merchant point-of-sale terminal that transmitted the transaction authorization request message,
said processor further programmed to:
transmit a one-time password request message to the merchant point-of-sale terminal; and
as part of the operation of receiving the calculated one-time password response value from the cardholder, receive the calculated one-time password response value from the merchant point-of-sale terminal.

5. The system in accordance with claim 4,
said processor further programmed to delay further processing for a predetermined period after transmitting the one-time password request message to the merchant.

6. The system in accordance with claim 4,
said processor further programmed to transmit a payment authorization response message to the merchant.

7. The system in accordance with claim 1,
said database comprising:
a rules table including one or more rules table records, with each table record including a primary key, a rule entry of the rule for producing the calculated one-time password response value, and an offset parameter component; and
a cardholder information table including one or more cardholder table records, with each cardholder table record including a foreign key and the payment card identifier, the foreign key referencing the primary key of the rules table.

8. The system in accordance with claim 7,
said processor being further programmed, as part of the operation of searching the database, to:
search the cardholder information table; and
identify a cardholder table record having the payment card identifier entry that matches the payment card identifier extracted from the transaction authorization request message.

9. The system in accordance with claim 8,
said processor further programmed to:
identify, from the cardholder table record, the foreign key referencing the primary key; and
identify, from the rules table, the rule entry referenced by the foreign key.

10. The system in accordance with claim 1,
the contact details for the cardholder including at least two methods of contact,
said processor being further programmed, as part of the operation of transmitting the generated one-time password to the cardholder, to transmit the generated one-time password using each of the methods of contact of the cardholder.

11. A method for authenticating a user with a one-time password having a one-time password offset parameter, said method comprising:
receiving a transaction authorization request message, the transaction authorization request message including the payment card identifier;
searching a database using the payment card identifier;
retrieving, from the database, contact details for the cardholder based on the payment card identifier;
generating a one-time password;
transmitting the generated one-time password to the cardholder using the contact details for the cardholder;
receiving a calculated one-time password response value from the cardholder;
retrieving, from the database, a rule for producing the calculated one-time password response value and a one-time password offset parameter;
producing a test one-time password from the one-time password offset parameter and the generated one-time password based on the retrieved rule;
comparing the calculated one-time password response value to the test one-time password; and
authenticating the calculated one-time password response value based on the calculated one-time password response value matching the test one-time password.

12. The method in accordance with claim 11, wherein the contact details for the cardholder include a preferred method of contact,
said operation of transmitting the generated one-time password to the cardholder further comprising transmitting the generated one-time password using the preferred method of contact of the cardholder.

13. The method in accordance with claim 12,
said method further comprising delaying further processing for a predetermined period after transmitting the generated one-time password to the cardholder.

14. The method in accordance with claim 11, wherein the transaction authorization request message includes information identifying a merchant point-of-sale terminal that transmitted the transaction authorization request message,
said method further comprising:
transmitting a one-time password request message to the merchant point-of-sale terminal; and
as part of the operation of receiving the calculated one-time password response value from the cardholder, receiving the calculated one-time password response value from the merchant point-of-sale terminal.

15. The method in accordance with claim 14,
said method further comprising delaying further processing for a predetermined period after transmitting the one-time password request message to the merchant.

16. The method in accordance with claim 14,
said method further comprising transmitting a payment authorization response message to the merchant.

17. The method in accordance with claim 1, wherein the database includes:
a rules table including one or more rules table records, with each rules table record including a primary key, a rule entry of the rule for producing the calculated one-time password response value, and an offset parameter component; and
a cardholder information table including one or more cardholder table records, with each cardholder table record including a foreign key and the payment card identifier, the foreign key referencing the primary key of the rules table.

18. The method in accordance with claim 17,
said operation of searching the database further comprising:
searching the cardholder information table; and
identifying a cardholder table record having the payment card identifier entry that matches the payment card identifier extracted from the transaction authorization request message.

19. The method in accordance with claim 18, said method further comprising:
identifying, from the cardholder table record, the foreign key referencing the primary key; and
identifying, from the rules table, the rule entry referenced by the foreign key.

20. The system in accordance with claim 11, wherein the contact details for the cardholder includes at least two methods of contact,
said operation of transmitting the generated one-time password to the cardholder further comprising transmitting the generated one-time password using each of the methods of contact of the cardholder.
